(19) United States
(12) Patent Application Publication
(10) Pub. No.: US 2003/0042305 A1
(43) Pub. Date: Mar. 6, 2003

(54) Electronic voting system

(76) Inventors: Bartholomeus Paulus, F. Jacobs, Nijmegen (NL); Martijn Diederik Oostdijk, Nijmegen (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/234,032

(22) Filed: Sep. 3, 2002

(30) Foreign Application Priority Data
Sep. 5, 2001 (EP) 01203355.1

(51) Int. Cl. G06F 17/60

(52) U.S. Cl. 235/386

(57) ABSTRACT

An electronic voting process sends votes that have been entered via a general purpose user interface such as the keyboard of a PC to a vote collecting system. To prevent viruses between the interface and the vote collecting system from entering fraudulent votes, individualized ballot forms are used. Each for a different voter and each containing entries for respective ones of the options that can be made in the vote. Entries for different options within each one of the forms contain mutually different identifiers, identifiers in entries for equal options in different ones of the forms containing mutually different identifiers. Each ballot forms is sent to the voter for which it was individually generated. The voter enters the identifiers for his or her option and a voting system compares the identifier with the information about the identifiers for the identified voter stored in the vote collecting system. The vote is counted for the option, if any, that corresponds to the data for the identified voter according to the information stored in the vote collecting system

The invention relates to an electronic system and process for collecting votes and to a set of ballot forms for use in such a system and process. As used herein “voting” will refer to any process in which a human user makes a selection between options and communicates that selection to a vote collecting authority.

The advent of modern electronic communication techniques has made it possible to hold elections in which voters don't need to go to conventional polling stations where officials receive voters and collect votes. For example, instead of entering his or her vote at a polling station, the voter may enter his or her vote at home using a PC, whereupon the PC transmits the vote to a server that counts votes from a plurality of voters and reports the result. Without a polling station, however, there are also no officials to check the identity of the voters and to ensure that the votes are cast by the identified voters.

For electronic voting these guarantees against fraud have to be replaced by technical measures to ensure that no fraud is possible. Most possibilities of fraud can be counteracted by the use of electronic signatures. An electronic signature adding device incorporates the vote into an electronic message in such a way that it can be verified that a specific voter has sent the message. A typical example of a signature adding device is a smart card. The voter is provided with a smart card that contains unique, secret information. The user enters his or her option in the vote, the smart card encodes (e.g. encrypts) the vote in a message using the secret information and the encoded vote is sent to the server. Upon reception of the message, the server verifies that the message has been encoded with the secret information of the voter and enters the vote only if this is so. Such a protection ensures that only legal voters, that are in possession of appropriate smart cards can send votes that will be counted. Of course, smart cards have only limited user interface facilities. Therefore, it is desirable that the user enters his or her option via the general input facilities of the PC, for example using the keyboard, the mouse or voice recognition etc. and that the PC feeds the option to the smart card to encode it in the message.

It has been found that this use of a general purpose user interface leads to another susceptibility to fraud. If the PC, or more generally any device that contains the user interface, is infected with a virus that intercepts communication between the PC and the smart card, there is a risk that such a virus can substitute a fraudulent vote for the vote entered by the voter, have the smart card encode this fraudulent vote and send a message with the fraudulent vote to the server. Thus, the fraudulent vote would be counted at the server.

Amongst others it is an object of the invention to provide for measures that reduce the risk that a virus that has infected the path between the user interface and the signature device can fraudulently select the voting option. The invention provides for an electronic voting system according to claim 1. According to the invention individualized ballot forms are used, in which the possible options that can be voted for correspond to identifiers that are different for different voters. Without knowledge of the ballot form, a virus in the path between the user interface and the vote collecting system is unable (or more precisely, very unlikely to be able) to insert valid fraudulent votes by inserting an identifier for a predetermined option.

Information about the identifiers is also stored in the vote collecting system. To vote, the voter enters the identifier for his or her option at the user interface. The identifier is compared with the stored identifiers for the voter. The vote is sent to a vote collecting system, which counts the vote for the option corresponding to the identifier. Preferably, the comparison between the stored identifiers and the entered identifier is performed in the vote collecting system.

The identifiers are for example numbers, or letter combinations that can be entered at a user interface. In an embodiment the identifiers are encoded as bar codes on a paper ballot form, or more generally as any machine readable code, so that the voter can enter the identifier for example by scanning it with a bar code scanner. Preferably, the identifiers are assigned randomly, or pseudo randomly, to the different options and voters, so that it is impossible (or more precisely very unlikely) to guess which identifier is assigned to a specific option for a specific user. It may be noted that the identifiers for the same option need not be different for all voters. Some voters may have the same identifier for one or more option. This is no problem as long as it is impossible to know which voters have the same identifiers.

Preferably, the identifier entered at the user interface is encoded with a signature adding device such as a smart card to make it possible for the vote collecting system to ensure that the vote really involves the identified voter. However, for protection against fraud by a virus this is not strictly necessary, since the use of the individualized ballot form already provides protection against fraud in this case. The signature adding device provides protection against voting after theft of the ballot form.

Preferably, the ballot form is sent to the voter outside the channel through which the identifier is sent back. For example, the ballot form is a paper form sent by normal mail, the identifier being sent back via a computer network like the Internet. Thus, the risk that a virus can access the ballot form to commit fraud is minimized. In principle, the invention can even be applied to votes where there is only a single voter.

In an embodiment, a closing identifier is included in the ballot form. When it receives the closing identifier the vote collecting system makes the vote final, foreclosing any possibility of changing the vote. Before the closing identifier is received, the voter may change his or her option, by sending the identifier for a different option to the vote collecting system. The vote collecting system will count the vote only for the option corresponding to the last received identifier. The closing identifier reduces the possibility of fraud by tampering with the vote after it has been cast.

Preferably, the closing identifier is included in a paper ballot form under a removable seal, which may be scratched out for example. This makes it possible to use the ballot form at a conventional ballot station as well. In this case, the officials at the ballot station should accept a vote from the voter only if the closing identifier on the ballot form has not been made accessible. Thus it can be ensured that no votes are entered into the ballot box for which electronic votes have already been finally cast.

In another embodiment the vote collecting system is arranged to send a confirmation message back to the user after receiving an identifier. The confirmation message identifies the option selected by the voter. Preferably, the confirmation message is sent prior to reception of the closing identifier. Thus, the voter is able to check whether the correct vote has been registered by the vote collecting system prior to finalizing the vote by sending the closing identifier. The confirmation message is sent for example by fax or telephone, to a telephone number specified by the voter during the vote.

In a further embodiment, the ballot form contains an opening identifier and the vote collecting system is arranged to accept votes for the voter only after receiving the opening identifier from the ballot form of the voter. Thus, it is ensured that someone without the ballot form can try to start casting votes for the voter.

The invention also relates to a voting process that uses the system according to the invention and a set of ballot forms for use in such a voting process.

These and other advantageous aspects and advantages of the system, method and set of forms according to the invention will be described in more detail using the following figures.

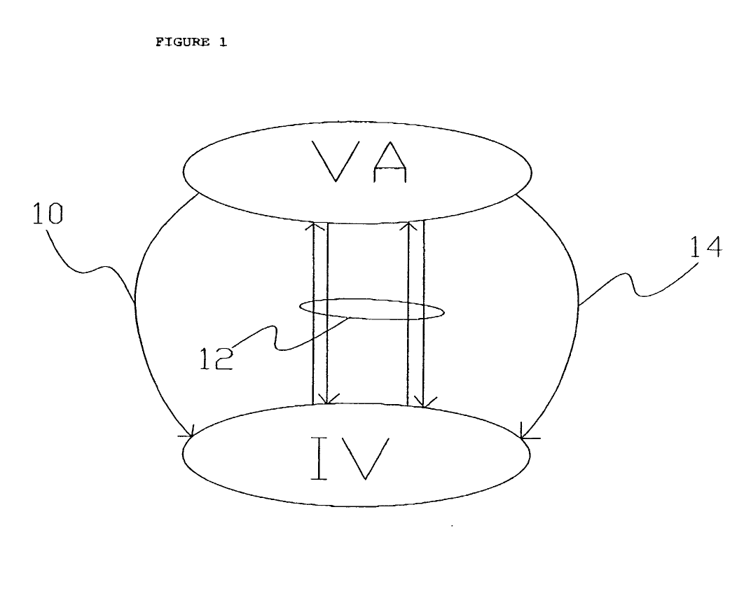

FIG. 1 shows communications between a voting authority and a voter

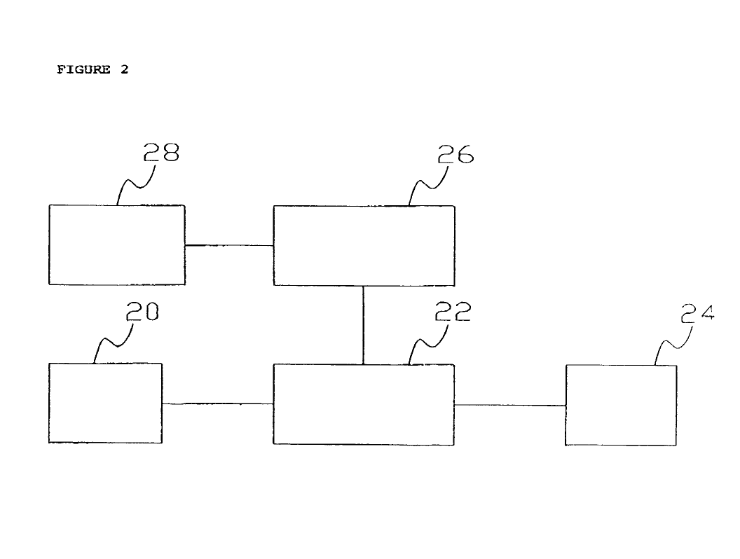

FIG. 2 shows a voting system

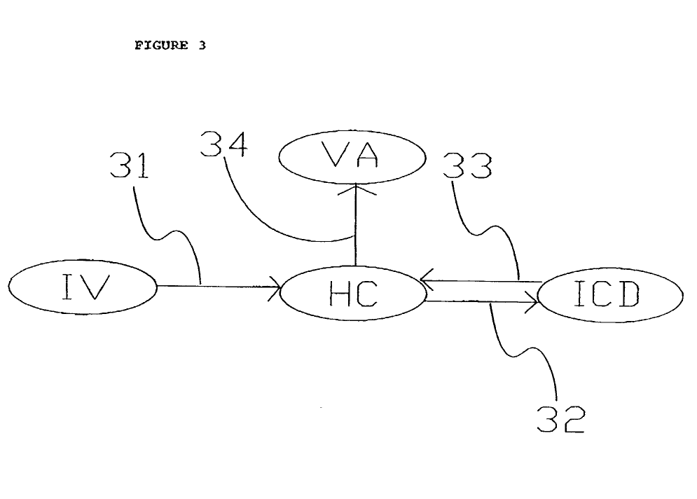

FIG. 3 shows communication between devices in a voting system

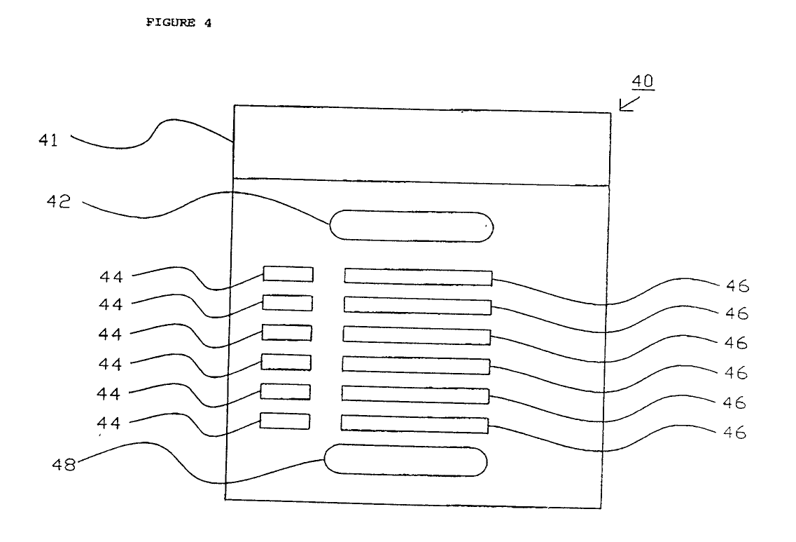

FIG. 4 shows a ballot form

The invention uses a protocol—called VSVPP for Voter-Side Virus Protection Protocol—for protecting electronic voting mechanisms against viruses that may be active on the computer of a voter. This protocol makes it extremely unlikely that such a voter-side virus can disrupt the voter transmitting the intended vote to the (on-line) voting authority, without detection. And in case such a disruption is detected, a new attempt on another computer can be made, or an ordinary vote can be cast in a physical voting station.

FIG. 1 illustrates messages 10, 12, 14 involved in the VSVPP protocol. The VSVPP involves multiple messages 10, 12, 14 between the voting authority (VA) and each individual voter (abbreviated as IV), which is assumed to be a human being. These messages will use the following three channels, in the given order.

Ordinary mail. This is used for sending a message 10 with a special ballot paper (or poll card) from the VA to each IV.

A Computer network. This is used for the electronic communications 12 between the VA and the IV, and in particular for transferring the actual vote from each IV to the VA.

Phone connection, possible wireless. This is used for transmitting a confirmation 14 of the vote from the VA to each IV who cast his/her vote via the computer network.

Transfer of messages 14 that include the electronic vote is indicated by multiple arrows, because this may involve multiple messages.

The key idea behind the VSVPP is to use a large collection of special identifiers to denote the possible options in an election. For each IV there is a unique subset of identifiers, in a one-one-correspondence with the options that is only known to the VA, and that is printed on a special ballot paper that is only usable by the IV. A virus that tries to influence the outcome of a vote will have to change identifiers. But since the correspondence between identifiers and options (for each IV) is a secret, the virus cannot change identifiers in a goal-directed manner—so that a particular option results.

VSVPP Assumptions

Preferably, the VSVPP works under the following assumptions.

There is an unspecified computer network, such as the Internet or a company network or some other network, which enables exchange of electronic messages between the VA and IVs, in both directions. There is no assumption that the computer network is reliable. For example, it may lose messages, or messages may be altered when transported by the computer network.

A vote is a special but unspecified message from an IV to the VA. It may for example contain a choice for a candidate or for a certain course of action, or something else. If a vote is transported from an IV to the VA via the computer network, it is called an electronic vote. Such a vote is typically encapsulated or encoded, so that it cannot be read or modified by others (than IV and VA), see below.

The actual processing of the votes that have been received by the VA—e.g. in order to determine the end result—is outside the scope of the VSVPP.

The VA is in control of voting stations whose purpose is to collect votes. There are both on-line voting stations connected to the computer network, and physical voting stations, where an IV can actually go to in order to cast his/her vote.

Each IV is known to the VA. The VA knows the ordinary mail address of each IV.

Each IV who wishes to cast an electronic vote is in possession of a (tamper-resistant) Individual Computing Device (abbreviated as ICD), such as a smart card, or an ibutton, or something else. Each ICD belongs to precisely one IV, called its owner. Each ICD carries a (electronic/digital) signature (or key), which enables the VA to link the ICD to its owner. Access to an ICD by others than the owner may be prevented via a Personal Identification Number (PIN), or via biometric identification, or via other such means.

For example, the secret key in an ICD may be the private key in a key pair <private key, public key> associated with the IV, as used in public-key cryptography; in this case the VA knows the (publicly known) link between IVs and their public keys, and can thereby link an ICD to its owner.

ICDs may be distributed as general citizen identity smart cards, or as company cards, or as something similar. Their use need not be restricted to just one election.

An ICD need not have an interface for direct communication with its owner. But it can be connected to a so-called host computer (or HC, for short). This may for instance be a personal computer at the home or work of an IV, with an Internet connection and a smart card reader. The HC is assumed to:

1) be connected to the computer network, so that it can send and receive messages;

2) provide an interface for the IV to communicate with the IDC (via the HC);

3) enable the IDC to send messages to the VA and receive messages from the VA, via the computer network (and via the HC).

FIG. 2 depicts the system used to collect votes. This system contains a user interface 10, a host computer 12, an individual computing device 14, a vote collecting system 16 and a memory device 18. There need not be a relation between an HC and an IV, like between an ICD and its owner IV: an IV should be able to use his/her ICD together with any appropriate HC. Also, an HC need not be reliable.

FIG. 3 illustrates the communications within the system of FIG. 2. An IV casts an electronic vote by means of entry of an identifier at the user interface 2, which performs a communication 31 by communicating the appropriate identifier for the vote via the HC 22, which performs a communication 32 of the identifier to the IDC 34, which performs a communication 33 back to the HC 32. The host then performs a communication 34 to the vote collecting system 26. The HC is assumed to be equipped with software which can (seem to) perform these transmission tasks, with appropriate input and output facilities (typically with keyboard and screen), as part of the interface with the IV.

The secret signature (or key) on the ICD is used for encoding and decoding messages on the ICD. Via such en-/decoding the ICD and VA can exchange encapsulated messages which (in principle) no-one else can read or modify—unless the secret signature on the ICD is compromised. Thus the integrity of messages 12 sent between the VA and ICD via HC is guaranteed. The VSVPP does not prescribe which kind of encoding/decoding should be used in order to ensure the integrity of communication between ICDs and the VA.

An election is an event when IVs may send their votes to the VA. An election has a beginning and an end. The voting stations under the control of the VA are open to receive votes from the beginning until the end of the election, but not outside this interval.

Voter-side Viruses

In this context, a virus is a special computer program running on the host computer (HC) 22 that may disrupt the voting process. The HC is then said to be infected. Because the virus runs on HCs that are used by IVs to express their votes, it is called a voter-side virus. The IV need not be aware of the possible presence of a virus on the HC that he/she uses for casting his/her electronic vote. (There may also be viruses on the side of the VA, but they are outside the scope of the VSVPP).

A concrete example scenario is the following. Voters are given the chance to decide on a certain issue by voting ‘yes’ or ‘no’. Before the election begins, a special election-disrupting “yes” virus may spread via the computer network, or via other means, and install itself on many HCs. The presence of such a virus may not even be noticed, because it need only become active during the election, and not before. When, during the election, an IV uses an infected HC to express his/her vote via the HC, the yes-virus may disregard this vote and cause the HC to always pass on ‘yes’ to the ICD, which passes this yes-vote on to the VA, after encoding it.

The purpose of the VSVPP is to detect a possible disruption of vote casting by such voter-side viruses. Upon detection of a disruption an IV can retry to cast his/her vote, either by using another (hopefully uninfected HC), or by physically casting the vote in an actual voting station. Since the VSVPP can detect possible disruptions, it may discourage undermining proper electronic voting.

VSVPP Ballot Paper

For convenience we assume that an election involves one or more choices among a number of options, say (option₁, . . . , optionₙ). For such an election the VSVPP prescribes a special ballot paper.

FIG. 4 shows a ballot paper 40 containing the different options of the election. Before the beginning of the election the VA sends by ordinary mail to each IV an individual ballot paper 40, which forms both an invitation to participate in the election and a means to vote. The ballot paper 40 may contain a header 41, with information about the nature of the election, the election date and the voter for which the ballot paper is valid. The information about the kind and date of the election on the ballet is irrelevant for the VSVPP.

The ballot paper 40 contains entries 44, 46 for the various options in the election. Each entry contains a printout 46 of the election option represented by the entry (for example yes or no, or the name of a candidate) and a generic printable identifier 44, such as a number, a word, a barcode, or something similar. The number of possible identifiers should be much larger than the number of options. An IV makes his/her choice for an option 46 by passing on the corresponding identifier 44, on the personal ballot paper for the IV, to a HC, which should pass it on to the IVs ICD, so that it can be transferred to the VA, as the vote of IV. This requires that the identifiers 44 related to options 46 should all be pairwise different on the ballot paper, so that the identifier can indeed be used to indicate a choice for individual options 46.

The listed options are (in principle) the same for all ballot papers of IVs, but the n+2 identifiers should be different between ballot papers 40 for different voters, or at least there should be a considerable number of ballot papers 40 with different identifiers.

The main point about the ballot paper for a particular IV is that it contains especially generated identifiers for this IV, which are known (only) to the VA. Especially, the relation identifier-option for this IV is known to the VA. Thus, if the VA knows IV, it knows which identifier corresponds to which option. In order to do this, the vote collecting system 26 of the VA is required to keep a secret database in memory device 28 in which this connection between each IV and the pairs (identifier-option) on his/her ballot paper are stored.

The ballot paper also contains first and last identifiers 42, 48, copies of which are also stored in the vote collecting system 26.

If the VA guards its secrets, a virus will never know the relation identifier-option for an IV. It will be able to change identifiers in an arbitrary way, but not in an intentional way, so that a specific option appears to be chosen. Moreover, if the number of identifiers is sufficiently large, there is a very small change that a virus will change an identifier chosen by an IV into another identifier which is actually related to another option for this IV. This is the essence of the protection against voter-side viruses offered by the VSVPP. The role of the first and last identifiers 42, 48 on the ballot paper 40, called will be explained in the following. Preferably these identifiers 42, 48 are covered (or sealed or stamped) with some removable (e.g. scratchable) layer, for indicating whether this identifier has been read. These covers should be such that, once removed, they cannot he restored without noticing.

VSVPP Voting Procedure

We consider an arbitrary IV with intention to vote in an election, in possession of his/her personal ballot paper, after the beginning of an election, but before the end. The VA organises two options for IV:

1) Non-electronic voting. In this case the IV actually goes to a physical voting station with his/her ballot paper to express his/her vote there, in an unspecified but standard non-electronic way (But a voting station may of course also offer HCs for electronic voting). Such a non-electronic vote is only allowed if the covering of the last identifier 48 on the IVs ballot paper is still there. In this process of voting, a representative of the VA removes the cover, and stores the vote as ‘confirmed’ in the database of the VA. This removal of the cover of the last identifier 48 is proof that the IV has cast his/her vote.

2) Electronic voting. In this case the IV is assumed to have access to a host computer HC 22, linked as in FIG. 2 to the computer network and IV with his/her ICD 24, and equipped with voting software which seemingly regulates the voting process. But note that this software (or the entire HC) may be infected with a virus. The IV then goes through the following series of steps, constituting an (electronic) voting session. If anything at any stage does not work as being described below, the IV should consider this attempt to vote disrupted, and abort the attempt. Then (s)he can either proceed to non-electronic voting as in 1. above, or look for another HC and restart the sequence of steps below.

3) The IV connects his/her own ICD to the HC, and starts the voting software that is assumed to be available on HC—either via downloading (securely) from the web, or via a special floppy from the VA, or via some other way.

4) The IV is asked to remove the cover of the first identifier 42 on the ballot paper, and pass this on to the HC 22, either by typing it on the keyboard in the user interface 20), or by reading it via a barcode reader in that interface 20, or by some other appropriate means.

The HC 22 passes this identifier 42 on to the ICD 24, which encodes it together with at least the ICD's 24 own identity (more information may be added like a time-stamp or nonce so that this voting session can be identified). The ICD 24 passes the encoded information to the HC 22. The HC 22 sends the resulting message over the computer network to the VA 26. The VA 26 decodes the message, and checks in its database in memory 28 whether the identifier 42 from the ballot box belongs to the IV—whose identity it can derive from the identity of his/her ICD 24. Also, the VA 26 checks that there is no confirmed vote yet for the IV. The VA 26 sends a reply message to the HC 22, containing a unique identification for this voting session, and saying either ‘proceed’, if the identifier that was sent belongs to the IV and there is no confirmed vote, and ‘abort’ otherwise. In the latter case the IV is not using the right ballot paper or has already cast his/her vote, and the current voting session is terminated. The step checking of the first identifier 42 is not really essential to the VSVPP, but is included to decrease the chance of disruption. Also, the covering of the first identifier 22 on the ballot paper 40 is not essential; it can only tell the IV whether or not someone has tried to misuse his/her ballot paper.

Assuming the ‘proceed’ message is sent by the VA, decoded by the ICD, and displayed by the HC, the IV can proceed to enter, at interface 20 of HC 22, his/her identifier 44 corresponding to the option 46 chosen by IV from his/her ballot paper 40. One or more identifiers may have to be entered, depending on the kind of election that is taking place. At the end of this, the IV also enters the phone (or fax) number at which he/she wants to receive confirmation of his/her vote from the VA 26.

All this information is passed on by the BC to the ICD, which again encodes it together with an identification tag of this voting session, and sends it via the HC to the VA. The VA decodes this message, and checks that it belongs to a currently running voting session via the identification tag. It looks if the identifier(s) contained in the message really belong to an option—using the relations identifier-option that VA stores for IV in its database. If not, the VA terminates the voting session, possibly after sending an abort message to the ICD. If the identifier(s) match options stored in memory 28 for the IV, these options are stored as the vote of IV. At this stage, the VA considers the voting session to be ‘unconfirmed’. This means that it can still be altered, but only as part of a new (electronic or non-electronic) voting session.

(As described above, the VA checks whether the given identifier(s) really correspond to options for the IV. Such a check may also be done by the ICD, if the VA tells in a previous (encoded) message to the ICD which of all the possible identifiers are appropriate. In this case the ICD can already abort a voting session, and will only send an acceptable identifier, if any, to the VA. But this alternative is less secure, because the list of appropriate identifiers is secret information, and should not leave the VA. However, it does not affect the main idea of the VSVPP). Also it is not necessary that the database contains the full identifier. Instead it may contain the result of evaluating a “one-way” function (as known from encryption techniques) with the identifier as argument. In this case the one-way function with the identifier as argument is evaluated and the result is compared with the stored information. This allows additional security, since it makes it difficult to cheat even if the virus has access to the database.

Once the VA has received the identifier and translated it into a valid option, the VA does two things:

It uses the phone number given by IV to transfer a message (for example voice/fax/sms/other) to IV telling him/her what the option(s) are that are currently stored as his/her vote.

It sends a message to the ICD asking for confirmation.

In case the phone message contains the same option(s) that the IV has chosen, the IV removes the cover from the last identifier 48 at his/her ballot paper 40 and enters it to the HC at this stage. The HC passes this identifier on to the ICD, which transmits it securely as part of the current voting session to the VA. Upon successful decoding of this message and successful checking of this last identifier (against the one in the database for IV), the VA consider this vote to be confirmed. It can then no longer be altered.

This removal of the covering of the last identifier is the physical sign that IV has voted. So it should only be removed at the very last stage, after the phone message coincides with the vote intended by IV. If the covering is still present, the IV can still change his/her vote, or start a new voting session, either electronically or non-electronically.

An interesting question is what to do with the votes which are still unconfirmed at the end of the election. One option is to discard them, but another is to count them, but only at the end of the election when they can no longer be changed. The latter seems reasonably, but the choice between these alternatives is best decided by the organisers of an (electronic) election. Also, the organisers may want to limit the number of times that a vote can be changed.

1. An electronic voting system for collecting votes for one or more options from a plurality of voters, the system comprising
means for generating individualized ballot forms, each for a respective one of the voters, each containing entries for respective ones of the options, each entry containing an identifier, the identifiers being selected so that entries for different options within each one of the forms contain mutually different identifiers, identifiers in entries for equal options in different ones of the forms containing mutually different identifiers;
a memory device for storing information about the identifiers entered for different options for different voters in a vote collecting system;
a user interface for entering data purportedly representing one of the identifiers from a voting voter;
an input device for receiving an identification of the voting voter;
a vote translating unit arranged to compare the data with the information from the memory about the identifiers for the identified voter;
a vote collecting system to count a vote for the option, if any, that corresponds to the data for the identified voter according to the information.

2. An electronic voting system according to claim 1, wherein the means for generating individualized ballot forms are arranged to add a closing identifier to each form, mutually different closing identifiers being selected for different forms, the transmitter being arranged to send further data captured from the user interface and purportedly representing the closing identifier to the vote collecting system, the vote collecting system being arranged to allow changes of the vote, but only up to reception of the closing identifier.

3. An electronic voting system according to claim 1 or 2, wherein the means for generating individualized ballot forms are arranged to add an opening identifier to each form, the transmitter being arranged to send further data captured from the user interface and purportedly representing the opening identifier to the vote collecting system, the vote collecting system being arranged to enter into a vote reception protocol only upon reception of the opening identifier.

4. An electronic voting system according to claim 1, 2 or 3, wherein the vote collecting system is arranged to send a vote confirmation message identifying the option corresponding to the identifier received by the voting system back to the voter upon reception of the identifier.

5. An electronic voting process for collecting votes for one or more options from a plurality of voters, the process comprising
generating individualized ballot forms, each for a respective one of the voters, each containing entries for respective ones of the options;
including identifiers in the entries, so that entries for different options within each one of the forms contain mutually different identifiers, identifiers in entries for equal options in different ones of the forms containing mutually different identifiers;
storing information about the identifiers entered for different options for different voters in a vote collecting system;
sending each ballot form to the voter for which that form was generated;
entering data purportedly representing one of the identifiers from a voting voter via a user interface at a remote station;
entering an identification code of a voter;
comparing the data with the information from the vote collecting system about the identifiers for the identified voter;
counting a vote for the option, if any, that corresponds to the data for the identified, voter according to the information stored in the vote collecting system.

6. An electronic voting process according to claim 5, wherein a closing identifier is included in each of the forms, mutually different closing identifiers being included for different forms, the vote collecting system being arranged to allow changes of the vote, but only up to reception of the closing identifier.

7. An electronic voting process according to claim 6, wherein the ballot forms are printed on paper, an area of the form where the closing identifier is printed being covered by a irreversibly removable seal.

8. An electronic voting process according to claim 5, 6 or 7, wherein an opening identifier is added to each form, the transmitter being arranged to send further data captured from the user interface and purportedly representing the opening identifier to the vote collecting system, the vote collecting system being arranged to enter into a vote reception protocol only upon reception of the opening identifier.

9. An electronic voting process according to claim 5, 6, 7 or 8, comprising sending a vote confirmation message back to the voter from the vote collecting system upon reception of the identifier, the vote confirmation identifying the option selected corresponding to the identifier.

10. A set of ballot forms for use in a vote for a plurality of options, each ballot form being for a different voter, each ballot form comprising a plurality of entries, each for a possible option in a vote, each entry comprising an identifier identifying the option, the identifiers for a same option on ballot forms for different voters being mutually different.

11. A set of ballot forms according to claim 10, printed on paper, each ballot form comprising a closing identifier covered by an only irreversibly removable seal.
